(19) United States
(12) Patent Application Publication
(10) Pub. No.: US 2024/0408670 A1
(43) Pub. Date: Dec. 12, 2024

(54) ARTICLE COMPRISING NON-WELDABLE SUPERALLOYS AND METHODS OF MANUFACTURE THEREOF

(71) Applicant: UNIVERSITY OF MASSACHUSETTS, Boston, MA (US)

(72) Inventors: Wen Chen, Worcester, MA (US); Jian Liu, Amherst, MA (US)

(21) Appl. No.: 18/671,475

(22) Filed: May 22, 2024

Related U.S. Application Data
(60) Provisional application No. 63/506,948, filed on Jun. 8, 2023.

(51) Int. Cl. B22F 1/103; B22F 1/05; B22F 1/107; B22F 3/10; B22F 3/20; B22F 3/24; B22F 9/08

(52) U.S. Cl. CPC B22F 1/103; B22F 1/05; B22F 1/107; B22F 3/10; B22F 3/20; B22F 3/24; B22F 9/082; B22F 2003/248; B22F 2009/0824; B22F 2201/02; B22F 2201/11; B22F 2301/15; B22F 2304/10; B22F 2998/10

(57) ABSTRACT

An ink formulation for manufacturing a non-weldable superalloy, the ink formulation including: a superalloy particle, the superalloy particle including a primary element of Ni, Co, Fe, or a combination thereof, and a secondary element including an element of Group 4 to Group 14, or a combination thereof, of the Periodic Table of the Elements, other than the primary element, wherein the superalloy particle has a size of less than 30 micrometers; a binder including a polymer, and a solvent.

### CROSS-REFERENCE TO RELATED APPLICATION

This application is based on and claims priority to U.S. Provisional Application No. 63/506,948, filed on Jun. 8, 2023, in the U.S. Patent and Trademark Office, and all the benefits accruing therefrom under 35 U.S.C. § 119, the content of which is incorporated by reference herein in its entirety.

### BACKGROUND

### Field

Disclosed herein is an article comprising non-weldable superalloys and methods of manufacture thereof. In particular, disclosed herein is an ink formulation that comprises non-weldable superalloy particles that permits the manufacturing of articles using additive manufacturing.

### Description of the Related Art

Superalloys containing predominantly nickel (Ni), cobalt (Co), iron (Fe) are used in the manufacture of aircraft and power generation turbines, rocket engines, and other extreme environments due to their superior mechanical properties and high thermal stability. Of these, Ni-containing superalloys are a family of alloy systems that comprise a predominantly Ni matrix with the addition of many other alloying elements such as Ta, Cr, Al, Mo, Co, Ti, Zr, and C. The success of many Ni-containing superalloys arises from the tailored microstructures mainly comprising ordered intermetallic precipitates (Ni, Co)₃(Al, Ti) known as γ′ precipitates, austenitic γ matrix, and some additional carbides that are rich in refractory elements. While the γ matrix is a disordered face-centered cubic (FCC) phase, the γ′ precipitates are a class of ordered L1₂ phases that are introduced into the matrix by heat treatment (e.g., aging). These precipitates can produce a precipitation-hardening mechanism to strengthen the γ matrix during deformation. To enhance the strength of Ni-containing superalloys at ambient and elevated temperatures, high volume fractions of γ′ precipitates are intended and these Ni-containing superalloys are called high-γ′ superalloys.

The advent of computational tools for more efficient mechanical and thermal designs of aerospace components has resulted in increasingly complex geometries for Ni-containing superalloy parts. Additive manufacturing, also called three-dimensional (3D) printing, is a powerful approach to producing net-shaped components layer by layer for applications in aerospace, automotive, biomedical, and other industries. With the tremendous advances in the development of laser or electron beam fusion-based 3D printing systems, additive manufacturing of Ni-containing superalloys has garnered much interest in recent years. However, while high-γ′ superalloys often possess improved mechanical properties with the benefit of large volume fractions of γ′ precipitates, they are difficult to weld or print by fusion-based additive manufacturing due to their high susceptibility to cracking.

Thus, there is a demand for an improved additive manufacturing process to manufacture non-weldable high-γ′ superalloys possessing enhanced mechanical properties.

### SUMMARY

To address the challenges, disclosed herein is an ink formulation including a non-weldable superalloy particle to manufacture an article including a non-weldable superalloy. Disclosed herein too is an article including the non-weldable superalloy and methods of manufacture thereof. In particular, the methods of manufacturing may be applicable to direct ink writing (DIW) combined with thermal sintering to manufacture a non-weldable high-γ′ superalloy.

Disclosed is an ink formulation for manufacturing a non-weldable superalloy, the ink formulation including: a superalloy particle, the superalloy particle including a primary element of Ni, Co, Fe, or a combination thereof, and a secondary element including an element of Group 4 to Group 14, or a combination thereof, of the Periodic Table of the Elements, other than the primary element, wherein the superalloy particle has a size of less than 30 micrometers; a binder including a polymer; and a solvent.

Disclosed is an article including a non-weldable superalloy, the non-weldable superalloy including: a primary element of Ni, Co, Fe, or a combination thereof; and a secondary element including an element of Group 4 to Group 14, or a combination thereof, of the Periodic Table of the Elements, other than the primary element, wherein a microstructure of the non-weldable superalloy includes a γ′ precipitate having a trimodal phase (e.g., trimodal distribution), wherein a content of the γ′ precipitate is at least 60%, based on a total volume of the non-weldable superalloy, and a γ matrix.

Disclosed is a method of fabricating the article, the method including: providing an ink formulation including a superalloy particle, the superalloy particle including a primary element of Ni, Co, Fe, or a combination thereof, and a secondary element including an element of Group 4 to Group 14, or a combination thereof, of the Periodic Table of the Elements, other than the primary element, wherein the superalloy particle has a size of less than 30 micrometers, a binder including a polymer, and a solvent; optionally mixing the ink formulation to provide a homogeneous ink formulation; loading the ink formulation into an extrusion device; pressurizing and extruding the ink formulation in the extrusion device through a nozzle to provide an extruded filament; and sintering the extruded filament thermally to fabricate an article including the non-weldable superalloy.

### BRIEF DESCRIPTION OF THE FIGURES

FIGS. 1A, 1B, and 1C are each a graph of distance (nanometer, nm) versus composition (atomic %, at. %) and shows a 1-dimensional concentration profile for composition variations across the interface between the γ matrix and the primary (FIG. 1A), secondary (FIG. 1B), and tertiary (FIG. 1C) γ′ precipitates, respectively, of the microstructure of an embodiment of additively manufactured (AM) Mar-M247 superalloy sintered at 1310° C. for 12 hours;

FIG. 1D is a graph of distance (nm) versus composition (at. %) and shows a 1-dimensional concentration profile for composition variations across the interface between the MC metal carbides and γ′ precipitates, of the microstructure of an embodiment of AM Mar-M247 superalloy sintered at 1310° C. for 12 hours;

FIGS. 2A1 to 2D each shows tensile properties of embodiments of additively manufactured (AM) Mar-M247 superalloys, as compared with Mar-M247 made by casting and binder jetting;

FIG. 2A1 is a graph of tensile stress (megapascals, MPa) versus tensile strain (%), and shows the results of tensile stress-strain curves of AM Mar-M247 superalloys by supersolidus liquid phase sintering (SLPS) at 1310° C. for 12 hours and by solid-state sintering (SSS) at 1280° C. for 8 hours;

FIG. 2A2 illustrates the different orientations tested for the SLPS embodiment in FIG. 2A1, which revealed nearly isotropic mechanical properties;

FIG. 2B is a graph of ultimate tensile strength (UTS) (MPa) versus uniform elongation (%) for embodiments of Mar-M247 superalloys produced by direct ink writing (DIW)-based additive manufacturing (labeled as this work), and collected data of traditional casting, and binder jetting additive manufacturing;

FIG. 2C is a graph of volume fraction of strengthening phase times tensile yield strength (MPa) versus uniform elongation (%) of AM Mar-M247 compared with those of high-performance commercial AM superalloys with high strength (σ_{0.2}>700 MPa) in the literature;

FIG. 2D is a graph of yield strength (MPa) versus temperature (° C.) and shows tensile properties of Mar-M247 at elevated temperatures;

FIGS. 3A to 3D each shows results related to the lattice strain measurements and stress partitioning in FCC/L12 phases and MC carbides of an embodiment of the 1310° C./12 hour Mar-M247 by in situ synchrotron X-ray diffraction (SXRD);

FIG. 3A is a graph of true stress (MPa) versus elastic lattice strain and shows the results of the evolution of lattice strain over macroscopic true stress for representative crystallographic plane families. The macroscopic yield stress is marked with the dashed line;

FIG. 3B is a graph of true stress (MPa) versus true strain, and shows the results of the macroscopic stress-strain curve and stress partitioning responses of FCC and L12 phases;

FIG. 3C is a graph of normalized intensity (arbitrary units, a.u.) versus spacing (angstroms, Å) and strains (E, %), and shows results of the representative diffraction spectra of the Mar-M247 superalloy at different strains ( ) along loading direction;

FIG. 3D is a graph of dislocation density (×10¹⁴ m⁻²) versus true strain and shows the dislocation density as a function of true strain in the Mar-M247 alloy;

FIG. 4A is a graph of heat flow (milliWatts, mW) versus temperature (° C.) and shows the results of a continuous heating DSC curve for Mar-M247 superalloy;

FIG. 4B is a graph of temperature (° C.) versus time, and shows the heating profile used for SLPS of Mar-M247 superalloy solution at 1310° C. for 12 hours;

FIG. 4C is a graph of mass fraction of phases versus temperature (C) and shows Thermo-Calc calculations of phase equilibria in the Mar-M247 superalloy as a function of temperature;

FIGS. 5A and 5B are each a graph of composition (at %) versus distance (nm) showing composition comparison across the interface between (A) the primary γ′ precipitates and the secondary γ′ precipitates, and (B) the primary γ′ precipitates and the tertiary γ′ precipitates, respectively;

FIG. 6 is a graph of tensile stress (MPa) versus tensile strain (%) showing tensile properties of the Mar-M247 samples sintered at different temperatures;

FIG. 7A is a graph of normalized intensity (a.u.) versus d spacing (Å) and shows a synchrotron X-ray diffraction (SXRD) pattern of an embodiment of another AM non-weldable superalloy of IN-100 sintered at 1250° C. for 9 hours with a similar microstructure of FCC+L1₂+MC carbides; and

FIG. 7B is a graph of tensile stress (MPa) versus tensile strain (%) and shows the tensile properties of an embodiment of an AM IN-100 superalloy sintered at 1250° C. for 9 hours.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within +30%, 20%, 10% or 5% of the stated value. Endpoints of ranges may each be independently selected.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

A detailed description of one or more embodiments of the disclosed non-weldable alloy and method of manufacturing the same are presented herein by way of exemplification and not limitation with reference to the Figures.

Disclosed herein are articles manufactured from superalloys that are typically non-weldable. These superalloys are typically difficult to fuse together to form an article or susceptible to cracking. The method disclosed herein comprises providing an ink formulation that comprises pre-alloyed particles of the non-weldable superalloys (hereinafter superalloy particles), a binder and a solvent. The ink formulation is then extruded onto a substrate and heated followed by cooling without aging to form the article. After the heating and cooling, the superalloy particles are sintered together to form the article including a high volume fraction of a desired phase (e.g., γ′ precipitate). The method also prevents the formation of undesired compounds such as M₂₃C₆ metal carbides that are typically brittle.

This method is advantageous because it provides a route to obtaining articles from non-weldable superalloys, which are otherwise difficult to fabricate, in particular without cracking. Further, this method provides non-weldable superalloys having improved mechanical properties compared to commercial non-weldable superalloys. These articles may be used in many high temperature applications such as aircraft, turbines, and the like.

### Ink Formulation

The ink formulation for manufacturing an article from the non-weldable superalloy comprises a superalloy particle that has a size of less than 30 micrometers; a binder that comprises a polymer; and a solvent. The superalloy particle comprises a primary element of Ni, Co, Fe, or a combination thereof, and a secondary element comprising an element of Group 4 to Group 14, or a combination thereof, where the secondary element is different from the primary element.

### Superalloy Particles

The superalloy particles can comprise particles of nickel-containing superalloys, cobalt-containing superalloys, iron-containing superalloys, and the like, or a combination thereof. A particle herein may be interchangeably used with powder, particulate, grain, and the like.

Nickel-containing superalloys exhibit high strength, creep resistance, and corrosion resistance at elevated temperatures, and are used in high-temperature applications, particularly in the aerospace and power generation industries. Nickel-containing superalloys contain nickel as the primary alloying element, and nickel is the most common primary element in superalloys. Nickel-containing superalloys may further comprise cobalt, molybdenum, rhenium, chromium, tantalum, aluminum, zirconium, tungsten, hafnium, carbon, and the like, or a combination thereof. Examples of nickel-containing alloys include Mar-M247, CMSX-4, IN-100, Rene N5, Rene 104, Rene 95, Rene 142, Rene 80, Rene 41, CM-247, CM247LC, K418, Haynes 282, Waspaloy, IN-718 (Ni-52.5Cr-19Fe-18.5Ni-3Mo-5Nb), IN-738, IN-738LC, IN-939, RR1000, IN-625, IN-713, Nimonic 90, Udimet 720, Hasteralloy-X, U700, or U-720.

Cobalt-containing superalloys can be used in extreme conditions of high temperature exposition, applied mechanical stresses and contact with chemically aggressive gaseous or molten media. Cobalt-containing superalloys contain cobalt as the primary alloying element. Cobalt-containing superalloys may also contain chromium, tungsten, molybdenum, niobium, and nickel amongst other metals. Other metal additives may optionally include carbon, silicon, manganese, tungsten, phosphorus, sulfur, nitrogen, aluminum, titanium, boron, or a combination thereof. Examples of cobalt-containing alloys include Co-30Ni-10Al-5Mo-2Nb, Co-30Ni-10Al-5Mo-2Ta-2Ti, Co-30Ni-11Al-5.5W-4Ti-2.5Ta-0.1B, Co-36.4Ni-13.2Al-6Cr-3.5Ta-1W, Co-12V-4Ti, Co-30Ni-10Al-5W-4Ti-1Ta, Co-12Ti-4Mo, Co-28Cr-6Mo, Co-20Cr-15W-10Ni, Co-35Ni-20Cr-10Mo, Haynes 188 (Co-22Cr-22Ni-W), Haynes 25 (Co-25Cr-10W-Ni), L-605 (Co-50Cr-20Ni-15W), or FSX-414 (Co-30Ni-27Cr-3.2Ti-1.4Al).

Iron-containing superalloys offer high thermal stability, high-temperature strength, and corrosion resistance. Iron-containing superalloys are used in applications where high-temperature properties and cost considerations are important. Examples of iron-containing superalloys include Incoloy 800 (Fe-32Ni-20Cr), Incoloy 825 (Fe-42Ni-21.5Cr), or Ferralium 255 (Fe-11Ni-20Cr).

The primary element refers to a main element in a composition of the superalloy particle. The primary element may be Ni, Co, Fe, or a combination thereof. The primary element usually forms the matrix in the superalloy.

The secondary element refers to an element in the composition of the superalloy particle, other than the main element. For example, the secondary element may be an element from Group 4 to Group 14, or a combination thereof, of the Periodic Table of the Elements according to the International Union of Pure and Applied Chemistry (“IUPAC”) Group 1-18 group classification system. In particular, the primary element may be Ni, and the secondary element may be Ta, Cr, Al, Mo, Co, Ti, Zr, C, W, Fe, Hf, B, Nb, V, Si, Re, or a combination thereof.

The size of the superalloy particles in the ink formulation may be 30 micrometers (μm) or less, for example, 0.1 μm to 30 μm, 5 μm to 25 μm, or 10 μm to 20 μm. The particle size may refer to the length of the longest axis of the particle. An average size of the superalloy particles in the ink formulation may be 20 μm or less, for example, 0.1 μm to 20 μm, 5 μm to 18 μm, or 10 μm to 15 μm. The size may be calculated by analyzing the sizes of the particles by scanning electron microscopy, an average may be mean or median.

Using the superalloy particles (e.g., pre-alloyed superalloy particles) having the aforementioned size may contribute to having a denser non-weldable superalloy structure after sintering (e.g., heating), for example, compared with larger size particles often used for binder jetting applications. While not wanting to be bound by theory, the denser structure is expected to contribute to enhanced mechanical properties of the non-weldable superalloys.

In an aspect, using pre-alloyed superalloy particles may be beneficial over, e.g., using metal oxides to fabricate non-weldable superalloy via additive manufacturing, due to its less complicated and cheaper process, less volumetric shrinkage, and improved mechanical properties.

A weight ratio of the superalloy particle to a total solvent in the ink formulation may be, for example, 50:1 to 10:1, 40:1 to 20:1, or 35:1 to 25:1, but not necessarily limited thereto.

### Binder

The binder in the ink formulation may be any suitable binder applicable for holding the superalloy particles together and providing an appropriate shear viscosity during the fabrication of the non-weldable superalloy. The binder may include polymers. The binder may be non-reactive with the superalloy particles, soluble in the solvent, and thermally stable during an extrusion process of the non-weldable superalloy. The shear viscosity may be 80 pascal-seconds (Pa·s) to 130 Pa-s, 90 Pa·s to 120 Pa·s, 100 Pa·s to 110 Pa·s, or 102 Pa·s to 105 Pa·s. The shear viscosity refers to a measure of a fluid's resistance to flow under shear stress, and may be measured by a capillary viscometer, a rotational viscometer, a falling ball viscometer, a vibrational viscometer, or a rheometer.

Examples of polymer binder include organic polymers, the organic polymers may be selected from a wide variety of thermoplastic polymers, blend of thermoplastic polymers, thermosetting polymers, or blends of thermoplastic polymers with thermosetting polymers. The organic polymer may also be a blend of polymers, copolymers, terpolymers, or combinations comprising at least one of the foregoing organic polymers. The organic polymer can also be an oligomer, a homopolymer, a copolymer, a block copolymer, an alternating block copolymer, a random polymer, a random copolymer, a random block copolymer, a graft copolymer, a star block copolymer, a dendrimer, a polyelectrolyte (polymers that have some repeat groups that contain electrolytes), a polyampholyte (a polyelectrolyte having both cationic and anionic repeat groups), an ionomer, or the like, or a combination thereof. The organic polymers have number average molecular weights greater than 10,000 grams per mole (g/mole), greater than 20,000 g/mole, or greater than 50,000 g/mole, and may be less than 1000,000 g/mole.

Exemplary organic polymers include, thermoplastic polymers that can be used in the polymeric material include polyacetals, polyacrylics, polycarbonates, polyalkyds, polystyrenes, polyolefins, polyesters, polyamides, polyaramides, polyamideimides, polyarylates, polyurethanes, epoxies, phenolics, silicones, polyarylsulfones, polyethersulfones, polyphenylene sulfides, polysulfones, polyimides, polyetherimides, polytetrafluoroethylenes, polyetherketones, polyether ether ketones, polyether ketone ketones, polybenzoxazoles, polyoxadiazoles, polybenzothiazinophenothiazines, polybenzothiazoles, polypyrazinoquinoxalines, polypyromellitimides, polyguinoxalines, polybenzimidazoles, polyoxindoles, polyoxoisoindolines, polydioxoisoindolines, polytriazines, polypyridazines, polypiperazines, polypyridines, polypiperidines, polytriazoles, polypyrazoles, polycarboranes, polyoxabicyclononanes, polydibenzofurans, polyphthalides, polyacetals, polyanhydrides, polyvinyl ethers, polyvinyl thioethers, polyvinyl alcohols, polyvinyl ketones, polyvinyl halides, polyvinyl nitriles, polyvinyl esters, polysulfonates, polysulfides, polythioesters, polysulfones, polysulfonamides, polyureas, polyphosphazenes, polysilazanes, polypropylenes, polyethylenes, polyethylene terephthalates, polyvinylidene fluorides, polysiloxanes, or the like, or a combination thereof.

Examples of thermosetting polymers include epoxy polymers, unsaturated polyester polymers, polyimide polymers, bismaleimide polymers, bismaleimide triazine polymers, cyanate ester polymers, vinyl polymers, benzoxazine polymers, benzocyclobutene polymers, acrylics, alkyds, phenol-formaldehyde polymers, novolacs, resoles, melamine-formaldehyde polymers, urea-formaldehyde polymers, hydroxymethylfurans, isocyanates, diallyl phthalate, triallyl cyanurate, triallyl isocyanurate, unsaturated polyesterimides, or the like, or a combination thereof.

In particular, a block co-polymer of poly(methyl methacrylate)-poly(n-butyl acrylate) may be used as the binder.

A volumetric ratio of the superalloy particle to the binder may be 9.5:0.5 to 5.5:4.5, 8.5:1.5 to 6.5:3.5, or 7.5:2.5, but not necessarily limited thereto.

### Solvent

The solvent may be any suitable solvent applicable for dissolving or dispersing the superalloy particle and the binder in the ink formulation. It is desirable to use a solvent or a co-solvent that can solubilize the binder at room temperature. Solvents and co-solvents that can dissolve the binder at elevated temperatures may also be used. The solvent may be an organic solvent, or an inorganic solvent including water or an aqueous solvent, (i.e., a solvent that is compatible with water), a water-immiscible solvent, or a combination thereof. Supercritical and/or superheated fluids may also be used as solvents in some compositions. Liquid carbon dioxide may also be used. Ionic liquids may also be used.

The solvent may preferably be an organic solvent including tetrahydrofuran, 2-butoxyethanol, ethanol, acetone, methanol, toluene, xylene, dichloromethane, hexane, or a combination thereof. The solvents may be liquid aprotic polar solvents, polar protic solvents, non-polar solvents, or combinations thereof. Liquid aprotic polar solvents such as propylene carbonate, ethylene carbonate, butyrolactone, acetonitrile, benzonitrile, nitromethane, nitrobenzene, sulfolane, dimethylformamide, N-methylpyrrolidone, or the like, or combinations thereof. Polar protic solvents such as, water, methanol, acetonitrile, nitromethane, ethanol, propanol, isopropanol, butanol, or the like, or combinations thereof may be used. Other non-polar solvents such a benzene, toluene, methylene chloride, carbon tetrachloride, hexane, diethyl ether, tetrahydrofuran, or the like, or combinations thereof, may also be used. In an aspect, tetrahydrofuran and 2-butoxyethanol may be used as the solvent.

A weight ratio of the total solvent to the ink formulation may be, for example, 1:10 to 1:60, 1:20 to 1:50, 1:30 to 1:40, or 1:36, but not necessarily limited thereto.

### Method of Manufacturing an Article

To manufacture an article comprising a non-weldable superalloy, the ink formulation is loaded into an extrusion device, the loaded ink formulation is extruded through a nozzle to provide an extruded mixture (i.e., extruded filament, or extruded ink formulation). The extruded mixture is thermally sintered to form the article. Although not limited to a specific extrusion method, the ink formulation and the fabricating method to be provided may be optimized for additive manufacturing, particularly a direct ink writing (DIW) method. The DIW method combined with thermal sintering may form the article comprising improved mechanical properties.

The method of fabricating an article comprising a non-weldable superalloy comprises providing an ink formulation comprising a superalloy particle, a binder comprising a polymer, and a solvent. The superalloy particle comprises a primary element of Ni, Co, Fe, or a combination thereof, and a secondary element comprising an element of Group 4 to Group 14, or a combination thereof, other than the primary element, wherein the superalloy particle has a size of less than 30 micrometers. The method further comprises optionally mixing the ink formulation to provide a homogeneous solution, then loading the ink formulation into an extrusion device. The method further comprises pressurizing and extruding the ink formulation in the extrusion device through a nozzle to provide an extruded ink formulation, and sintering the extruded ink formulation thermally to fabricate the non-weldable superalloy.

The ink formulation to be provided is described above, and the details of the composition of the ink formulation may not be discussed further.

The ink formulation may be mixed to provide a homogeneous solution, for example, by planetary centrifugal mixing, high-speed stirring or agitation, ultrasonication, bead milling, or three-roll milling. After stabilization, the ink formulation may show a shear-thinning characteristic with a shear viscosity range of 80 Pa·s to 130 Pa·s, 90 Pa·s to 120 Pa·s, 100 Pa·s to 110 Pa·s. In particular, 102 Pa·s to 105 Pa·s may be desirable for DIW.

The ink formulation may be loaded into an extrusion device used in processing methods such as additive manufacturing including DIW systems, fused deposition modeling (FDM), or the like. For example, the extrusion device may include a pressurized DIW system, screw extruder, piston extruder, paste extruder, granule extruder, or the like.

In particular, the method of fabricating the article comprising the non-weldable superalloy may be beneficial over other fabrication methods, for example, a binder jetting method. Binder jetting involves powder-bed spreading superalloy particles, then selectively jetting e.g., polymer binders on the superalloy particles. On the contrary, the disclosed method involves providing a homogeneous mixture of the superalloy particles and the binder in an ink formulation first, then extruding the ink formulation. The pre-mixing of the superalloy particles and the binder to form a homogeneous mixture and the applied shearing stress on the ink formulation during extrusion may result in greater packing density of the particles after extrusion. Furthermore, the superalloy particle size of less than 30 micrometers in the aforementioned ink formulation may provide a denser structure after sintering.

The sintering of the extruded ink formulation (of the superalloy particles, the binder and residual solvent) may comprise placing the extruded ink formulation in a furnace under an inert atmosphere comprising argon, nitrogen, or a combination thereof, heating the extruded ink formulation until reaching a peak temperature, wherein the peak temperature is less than the solidus temperature of the superalloy or alternatively, greater than the solidus temperature and less than the liquidus temperature of the superalloy. The sintering may include maintaining the peak temperature for 3 hours to 15 hours to sinter the superalloy particles, and cooling the sintered superalloy particles. During the heating of the extruded mixture to a sintering peak temperature, solvent evaporates and the polymeric binder undergoes thermal degradation leaving behind only superalloy particles which can then undergo sintering.

The solidus temperature refers to the locus of temperatures (a curve on a phase diagram) below which a given substance is completely solid (crystallized). The liquidus temperature refers to the locus of temperature above which a material is completely liquid. The liquidus temperature of the superalloy is greater than the solidus temperature of the superalloy, and a mixture of solid and liquid exists between the liquidus temperature and the solidus temperature of the superalloy. A volume of liquid superalloy increases with respect to the total volume of superalloy as the temperature increases from the solidus temperature to the liquidus temperature.

The heating at the peak temperature greater than the solidus temperature and less than the liquidus temperature of the superalloy is to provide a supersolidus liquid phase sintering (SLPS). For example, the peak temperature may be between the solidus temperature and up to 20° C. greater, up to 15° C. greater, or up to 10° C. greater than the solidus temperature. SLPS involves heating a pre-alloyed powder between the solidus and liquidus temperatures, and contributes to the improved density and mechanical properties, including tensile stress, ultimate tensile strength, and uniform elongation. For example, for a Mar-M247 superalloy having a solidus temperature of 1304° C. and a liquidus temperature of 1362° C., the peak sintering temperature of 1305° C. to 1325° C., 1307° C. to 1315° C., or 1310° C., may be selected. The peak temperature may be maintained for 3 hours to 20 hours, 8 hours to 15 hours, 9 hours to 13 hours, or 12 hours. The peak temperature may also be greater than the formation temperature of each of M₂₃C₆ carbide and M₆C carbide, wherein M comprises an element of the primary element, the secondary element, or a combination thereof, other than carbon, and C is carbon. The heating at the peak temperature slightly less (up to 40° C. less) than the solidus temperature of the superalloy may also be used, which may result in a solid-state sintering. The peak temperature may be up to 40° C. less, up to 30° C. less, or up to 20° C. less than the solidus temperature and the solidus temperature of the superalloy. Solid-state sintering is the bonding and densification of particles by the application of heat below the melting point of a material, or below the solidus temperature of a superalloy.

While not wanting to be bound by theory, in the solid sintering process, surface diffusion and grain boundary diffusion are the most common transport processes but only grain boundary diffusion contributes to the densification. In liquid phase sintering process, capillary pressure will tend to rearrange the solid particles in such a way as to give maximum packing and a minimum of resultant pore surface with the help of liquid phase. In this case, the newly formed liquid penetrates between the solid grains, dissolves the sinter bonds, and induces grain rearrangement. Liquid phases lubricate and enhance sintering, especially since diffusion rates in liquids are 100-1000 times higher than in solids. As the elimination of pores, the grains undergo both size and shape changes by solid dissolution into the liquid, diffusion of that dissolved solid through the liquid, followed by reprecipitation of dissolved solid onto lower energy solid surfaces. This process is called solution-reprecipitation. This process allows the larger grains to grow at the expense of the smaller grains. Accordingly, the dissolving small grains are spherical, while the growing large grains are flat faced.

The cooling may be performed under ambient air, argon, nitrogen, or a combination thereof. The cooling, specifically without aging, is involved in the process of fabricating the non-weldable superalloy. Aging (which refers to holding the alloy at an elevated temperature for a specific duration of time following the initial solidification or solution treatment of a superalloy) is often used to allow the alloy's microstructure to undergo a series of precipitation reactions, leading to the formation of desired strengthening phases, such as γ′ precipitates in commercial nickel-based superalloys. On the contrary, the disclosed method of fabricating the non-weldable superalloy does not include an aging step, and directly proceeds to the cooling step to provide a desired microstructure of the non-weldable superalloy. For example, MC carbides, which are desirable compounds that contribute to improved mechanical properties, often can decompose to M₂₃C₆ as MC+γ→M₂₃C₆+γ′ during the ageing treatments in a Ni-containing non-weldable superalloy. By direct cooling without ageing after sintering, the formation of needle-like M₂₃C₆ carbides may be prevented and the trimodal γ′ phase may be directly formed, which may lead to improved mechanical properties. The MC carbide (i.e., MC metal carbide) herein refers to a compound of carbon (C) and a metal (M), wherein the stoichiometric ratio of M to C is 1:1. M may be a metal included in the superalloy, for example, an element of Group 4 to Group 14, or a combination thereof, of the Periodic Table of the Elements. Carbides having the stoichiometric ratio of M to C being x:y may be represented as MₓC_{y}. For example, M₂₃C₆ may have a stoichiometric ratio of M to C of 23:6.

The method of fabricating the article comprising the non-weldable superalloy may further comprises, before heating the extruded mixture to the peak temperature, heating the extruded mixture until reaching a first temperature of 100° C. to 150° C., and maintaining the first temperature for 0.1 hour to 3 hours, heating the extruded mixture until reaching a second temperature of greater than the boiling point of the solvent, and maintaining the second temperature for 0.1 hour to 3 hours, and heating the extruded mixture until reaching a third temperature greater than the decomposition temperature of the binder, and maintaining the third temperature for 0.1 hour to 3 hours. The heating at the first temperature is to ensure removal of water and may be 100° C. to 150° C., 100° C. to 130° C., or 110° C. to 120° C., and it may be maintained at the first temperature for 0.1 hour to 3 hours, 0.3 hour to 2 hours, or 0.5 hour to 1 hour. The heating at the second temperature is to ensure removal of the solvent and may be, for example for organic solvents including THF and 2-butoxyethanol, 175° C. to 300° C., 180° C. to 250° C., or 190° C. to 200° C., and it may be maintained at the second temperature for 0.1 hour to 3 hours, 0.3 hour to 2 hours, or 0.5 hour to 1 hour. The heating at the third temperature is to ensure removal of the binder and may be, for example for a block copolymer of poly(methyl methacrylate)-poly(n-butyl acrylate), 350° C. to 550° C., 380° C. to 520° C., or 400° C. to 500° C., and it may be maintained at the third temperature for 0.1 hour to 3 hours, 0.3 hour to 2 hours, or 0.5 hour to 1 hour. A heating rate may each be 5-20° C./min when reaching the first temperature, the second temperature, the third temperature, and the peak temperature.

The pressurizing and the extruding may be performed under a computer digital control, and wherein the extruded superalloy is deposited on a substrate as sequential layers to form a three-dimensional article. In particular, the method of fabricating the article comprising the non-weldable superalloy may be using a DIW system to deposit the extruded superalloy on the substrate as sequential layers to form the three-dimensional article.

### An Article Comprising a Non-Weldable Superalloy

Using the aforementioned ink formulation and manufacturing method, an article comprising a non-weldable superalloy having improved mechanical properties compared to commercial non-weldable superalloys can be manufactured. The article manufactured can be used for gas turbines, such as turbine blades, turbine discs, or turbine shrouds, for aerospace engines, such as compressor blades, or combustor components, or for other industrial processes that desire materials withstanding elevated temperatures and harsh environments.

The article comprises a non-weldable superalloy, and the non-weldable superalloy comprises: a primary element of Ni, Co, Fe, or a combination thereof; and a secondary element comprising an element of Group 4 to Group 14, or a combination thereof, of the Periodic Table of the Elements, other than the primary element. A microstructure of the non-weldable superalloy comprises a γ′ precipitate having a trimodal phase, wherein a content of the γ′ precipitate is at least 60%, based on a total volume of the non-weldable superalloy, and a γ matrix.

As noted above, the primary element refers to a main element in a composition of the non-weldable superalloy. The secondary element refers to an element in the composition of the non-weldable superalloy, other than the main element. In particular, the primary element may be Ni, and the secondary element may be Ta, Cr, Al, Mo, Co, Ti, Zr, C, W, Fe, Hf, B, Nb, V, Si, Re, or a combination thereof.

### Microstructure of the Non-Weldable Superalloy

The γ matrix is a solid solution of face-centered cubic (FCC) austenitic phase in the non-weldable superalloy. During the formation of the non-weldable superalloy, a γ′ phase, and carbides precipitate as they cool from the sintered article.

The γ′ precipitate is an intermetallic precipitate, which has an ordered L12 phase. The γ′ precipitate may be, for example, (Ni, Co)₃(Al, Ti). The γ′ precipitate contributes to enhanced mechanical properties and high thermal stability of non-weldable superalloys. The γ′ precipitate may be introduced by heat treatment.

The content of the γ′ precipitate is at least 60%, at least 65%, or at least 70%, for example, may be 60% to 99%, 65% to 95%, or 70% to 90%, based on the total volume of the non-weldable superalloy. To enhance the strengths of superalloys at ambient and elevated temperatures, high volume fractions of γ′ precipitates in the aforementioned ranges are desirable as it contributes to enhanced mechanical properties.

The γ′ precipitate in the disclosed non-weldable superalloy has a trimodal phase. The trimodal phase refers to having three different size ranges of γ′ phases, and comprises a primary γ′ phase having a largest size, secondary γ′ phase having a second largest size, and a tertiary γ′ phase having a smallest size. The specific size ranges and volume fractions of the γ′ precipitates in a trimodal distribution can vary depending on the composition and heat treatment conditions of the particular superalloy. For example, the primary γ′ phase may have a size of 300 nanometers (nm) to 1000 nm (1 μm), 500 nm to 900 nm, 600 nm to 800 nm, or 750 nm. For example, the secondary γ′ phase may have a size of 40 nm to 200 nm, 50 nm to 150 nm, 60 nm to 100 nm, or 74 nm. For example, the tertiary γ′ phase may have a size of 0.1 nm to 30 nm, 1 nm to 25 nm, 10 nm to 20 nm, or 15 nm.

The trimodal phase may be beneficial for achieving an optimal combination of strength, creep resistance, and toughness in the superalloy. Each size range of γ′ precipitates contributes differently to the alloy's overall mechanical behavior. The large γ′ precipitates provide high strength and resistance to creep deformation, while the intermediate-sized γ′ precipitates contribute to the alloy's fracture toughness. The small γ′ precipitates help to increase the yield strength and enhance the overall creep resistance of the material. By incorporating a trimodal distribution of γ′ precipitates, the superalloy aims to achieve a balance between strength, toughness, and creep resistance, thereby improving its overall performance at high temperatures. The specific size ranges and volume fractions of the γ′ precipitates in a trimodal distribution can vary depending on the composition and heat treatment conditions of the particular non-weldable superalloy.

The γ′ precipitate may be distributed uniformly in the γ matrix in the non-weldable superalloy.

The non-weldable superalloy may comprise an MC carbide, wherein M comprises an element of the primary element, the secondary element, or a combination thereof, other than carbon, and C is carbon. The MC carbide has a stoichiometric ratio of M to C of 1:1.

The non-weldable superalloy may have a rosette γ-γ′ eutectic carbide content of less than 1%, for example, 0% to 1%, 0.01% to 0.5%, or 0.1% to 0.3%, based on the volume of the non-weldable superalloy, a needle-like carbide content of less than 1%, for example, 0% to 1%, 0.01% to 0.5%, or 0.1% to 0.3%, based on the volume of the non-weldable superalloy, or a M₂₃C₆ carbide content of less than 1%, for example, 0% to 1%, 0.01% to 0.5%, or 0.1% to 0.3%, based on the total volume of the non-weldable superalloy. The MC carbide in currently available commercial superalloys may be decomposed to rosette γ-γ′ eutectic, needle-like MC carbides, or M₂₃C₆ carbides, or the like, and may be observed in interdendritic regions and grain boundaries largely due to elemental segregation during solidification. The much coarser γ′ precipitates and the needle-like carbides can cause earlier cracking under loading. On the contrary, the disclosed non-weldable superalloy may have a substantially small content of the rosette γ-γ′ eutectic carbide, the needle-like carbide, the M₂₃C₆ carbide, or a combination thereof, as described above. Preferably, the non-weldable superalloy may be free of the rosette γ-γ′ eutectic carbide, the needle-like carbide, the M₂₃C₆ carbide, or a combination thereof. In an embodiment, the non-weldable superalloy having the MC carbide and substantially small contents of the rosette γ-γ′ eutectic carbide, the needle-like carbide, the M₂₃C₆ carbide, or a combination thereof, contributes to the enhanced mechanical properties.

### Mechanical Properties of the Non-Weldable Superalloy

The non-weldable superalloy may have a uniform elongation of 13% to 19%, 15% to 19%, 13% to 17%, or 15% to 17%. In a tensile test, the uniform elongation is the percentage the gauge length elongated at peak load relative to the initial gauge length when measured as per ASTM E8/E8M standard.

The non-weldable superalloy may have an ultimate tensile strength (UTS) of 1250 megapascals (MPa) to 1450 MPa, 1275 MPa to 1425 MPa, or 1300 MPa to 1400 MPa. The ultimate tensile strength is the maximum stress a material can withstand before it fractures or breaks, and is measured in units of force per cross-sectional area when measured as per ASTM E8/E8M standard.

The non-weldable superalloy may have a high yield stress of 800 MPa to 1000 MPa, 850 MPa to 950 MPa, or 875 MPa to 925 MPa, comparable to that of conventional cast counterparts. The yield stress refers to the stress at which a material transitions from elastic deformation to plastic deformation when measured as per ASTM E8/E8M standard.

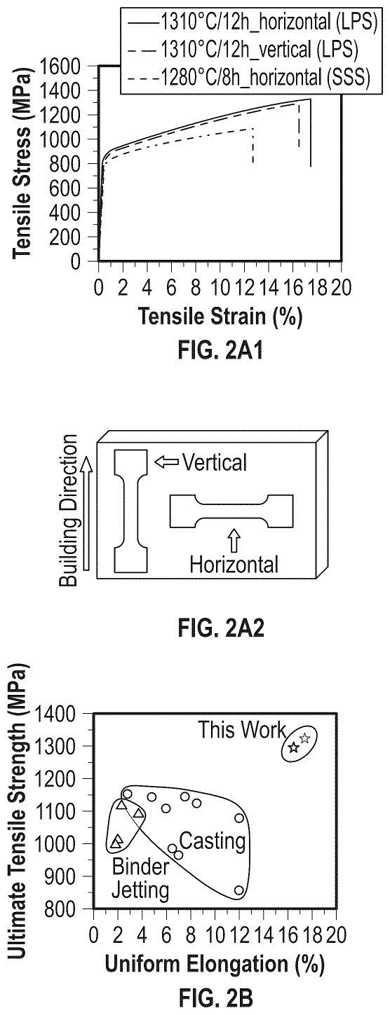

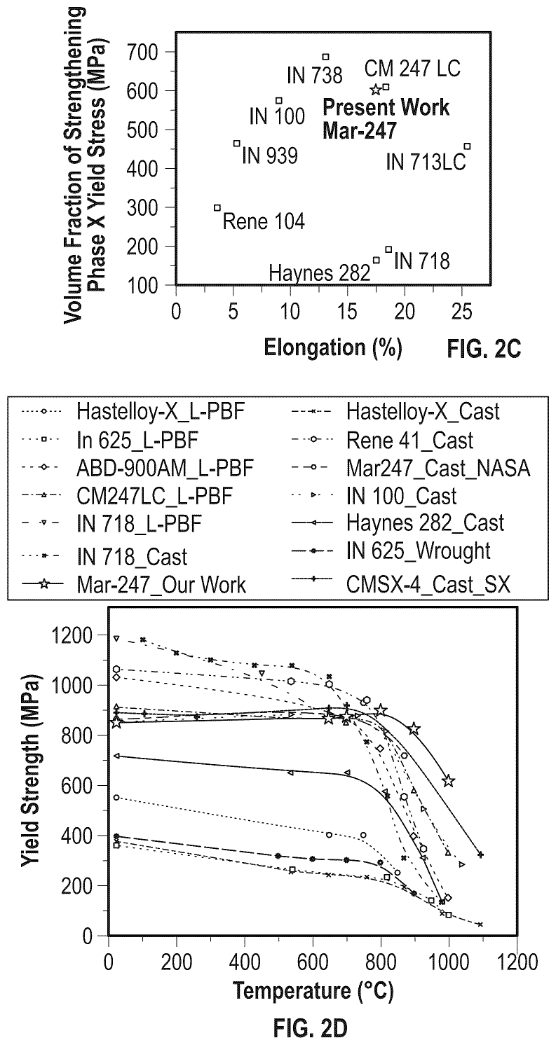

Of particular significance is the steady strain-hardening ability at high flow stresses, leading to the aforementioned large uniform elongation and the aforementioned high ultimate tensile strength. Notably, the outstanding combination of the uniform elongation and the UTS of the non-weldable superalloys well surpasses those of other non-weldable superalloys produced by casting or binder jetting additive manufacturing, as summarized in FIG. 2B.

The non-weldable superalloy may have a surface roughness of 0.1 μm to 3 μm, 0.5 μm to 2.5 μm, or 1 μm to 2 μm. The surface roughness (Ra) is determined by measuring the average of surface heights and depths across the surface (ISO 21920-2:2021). The non-weldable superalloys having the aforementioned surface roughness ranges may contribute to exhibiting a consistent mechanical performance. The surface roughness of commercial metal AM components, depending upon the material used, range from 9 μm to 50 μm. The high variation in surface roughness increases the uncertainty of a component's mechanical performance.

### Examples

The present inventive concept will be described in greater detail through the following examples. However, it will be understood that the examples are provided only to illustrate the present inventive concept and not to be construed as limiting the scope of the present inventive concept.

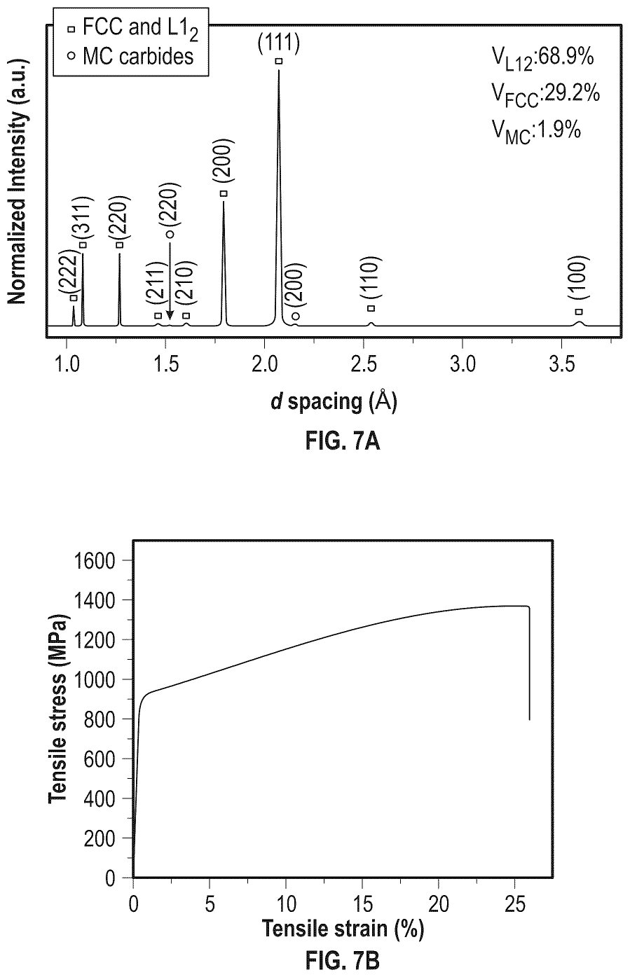

Commercially available superalloys Mar-M247 and IN-100 were used as two model systems to produce crack-free superalloys with a high-volume fraction (about 70%) of γ′ precipitate. The disclosed additively manufactured (AM) Mar-M247 superalloys demonstrated an improved combination of strength and ductility that well surpasses their counterparts produced by other manufacturing routes (FIG. 2B). Also, the IN-100 superalloy using paralleled fabrication method showed a desired microstructure and improved mechanical properties similar to Mar-M247, as shown in FIGS. 7A and 7B.

### Materials Fabrication

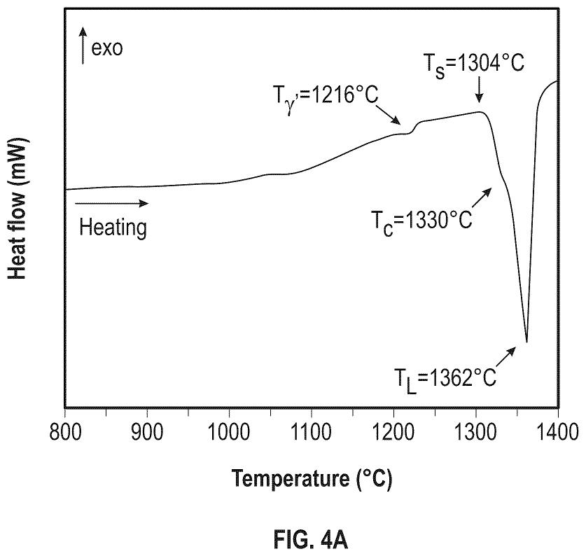

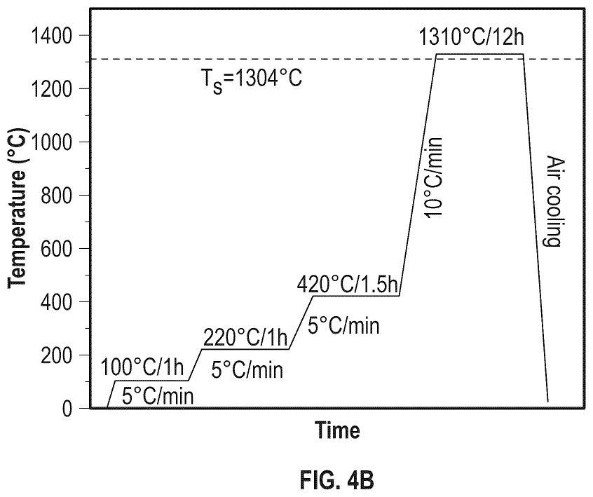

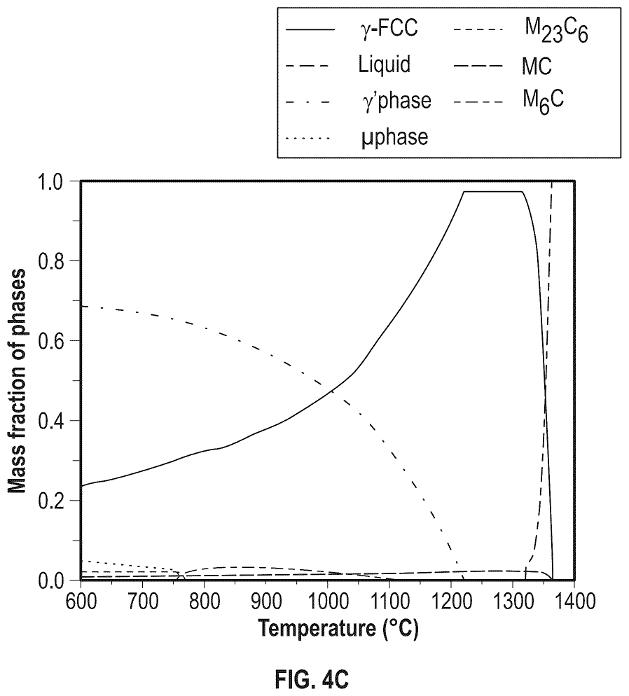

An ink formulation comprising organic solvents of 10 mL tetrahydrofuran (THF, Fisher Scientific) and 0.1 mL 2-butoxyethanol (Fisher Scientific), 0.75 gram poly(methyl methacrylate)-poly(n-butyl acrylate), i.e., PMMA-PnBA block co-polymer binder (Kuraray American, Inc.), and 33.2 grams pre-alloyed Mar-M247 micro-powders (i.e., superalloy particles) by gas atomization (size: <20 μm) was prepared. A volumetric ratio of 8.5:1.5 was adopted for the Mar-M247 micro-powders and the binding polymer, respectively, for the ink synthesis. To ensure homogeneity, the ink was mixed by a planetary centrifugal mixer (Thinky Are-310). After stabilization, the ink showed a typical shear-thinning characteristic with a shear viscosity range of approximately 102-105 Pa·s that is appropriate for DIW. The ink was thereafter loaded into a syringe-barrel (Nordson EFD) and pressurized through a tapered nozzle of 200 μm in diameter onto a planar alumina substrate under a computer digital control. The printed Mar-M247 samples were sintered in a tube furnace (KSL-1700X-KS, MTI) under the flowing Argon (99.99 wt %, 200 ml/min, Airgas). A multi-step heating profile with a heating rate of 5° C./min. was used to remove the moisture (100° C., 0.5 hr), organic solvents (200° C., 1 hr), and binding polymer (420, 1 hr), followed by thermal sintering at the peak temperature (1310° C., 12 hrs) with a heating rate of 10° C./min and eventually air-cooled. Note that such a peak sintering temperature of 1310° C. was selected to be higher than the solidus temperature of Mar247 (1304° C.) measured by differential scanning calorimetry (DSC) in FIG. 4A. To study the effect of sintering temperature on the mechanical properties of the AM Mar-M247, the samples were sintering at different conditions and the results are shown in FIG. 4A-4C.

### Mechanical Testing

Dogbone-shaped tension specimens with a nominal gauge dimension of 8 millimeters (mm) (length)×2 mm (width)×1 mm (thickness) were cut from the rectangular plates by electrical discharge machining and finally polished to a metallurgical grit of 1200 silicon carbide paper. Quasi-static uniaxial tension tests were performed on an Instron 5969 universal testing machine at a strain rate of 2×10⁻⁴ s⁻¹. The strain was measured by an Instron non-contact AVE2 video extensometer with a displacement resolution of 0.5 μm. The tests were repeated two to three times for each type of sample.

### In-Situ Synchrotron X-Ray Diffraction

In-situ synchrotron X-ray diffraction (SXRD) measurements were performed at the ID3A beamline of the Cornell High Energy Synchrotron Source. High-energy X-rays with an energy of 67.4 kiloelectronvolts (keV), a wavelength of 0.1839 angstrom (Å) and a beam size of 0.5×0.5 mm were used to obtain two-dimensional diffraction patterns in the transmission geometry using a detector placed downstream at 800 mm from the sample. RAMS2 tensile device was used for in situ tensile tests. The in situ tensile tests were performed at a strain rate of 5×10⁻⁴ s⁻¹. The phase weight fraction was determined by full-pattern Rietveld refinement using the GSAS software. The lattice strain for the {hkl} reflection, εₕₖₗ, was calculated by εₕₖₗ=(dₕₖₗ−d_{0,hkl})/d_{0,hkl}, where dₕₖₗ and d_{0,hkl} denote the interplanar spacings of {hkl} planes under loading and in the ‘stress free’ state.

### Microstructure Characterization

Transmission electron microscopy (TEM) specimens were first mechanically polished to about 100 μm in thickness, then punched into 3-mm-diameter disks. These disks were twin-jet electropolished using a Tenupol-5 polishing system with a solution of 5% perchloric acid, 35% butanol and 60% methanol at-40° C. All the specimens were first examined inside an FEI Tecnai TEM operating at 200 KeV.

Atom probe tomography (APT) specimens were prepared using a Thermo Fisher Nova 200 dual-beam focused ion beam/SEM. A triangular prism wedge was lifted out, sectioned, mounted onto silicon microtip array posts, sharpened using a 30-kV Ga+ ion beam and cleaned using a 2-kV ion beam. The APT experiments were run using a CAMECA LEAP 4000XHR in laser mode with a 30-K base temperature, 60-pJ laser energy, a 0.5% detection rate and a 200-kHz pulse repetition rate. The APT results were reconstructed and analyzed using CAMECA's interactive visualization and analysis software (IVAS 3.8).

### Thermal Sintering Determination

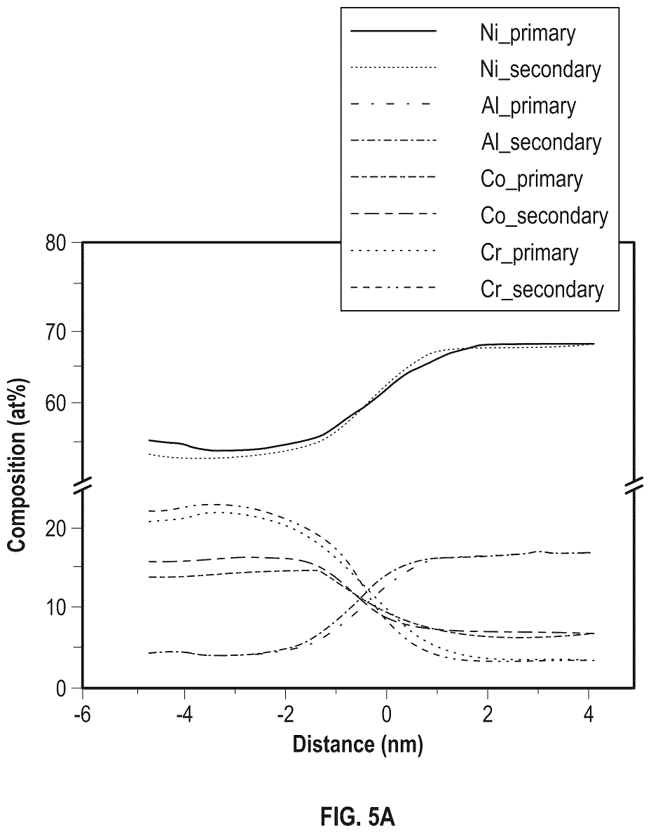

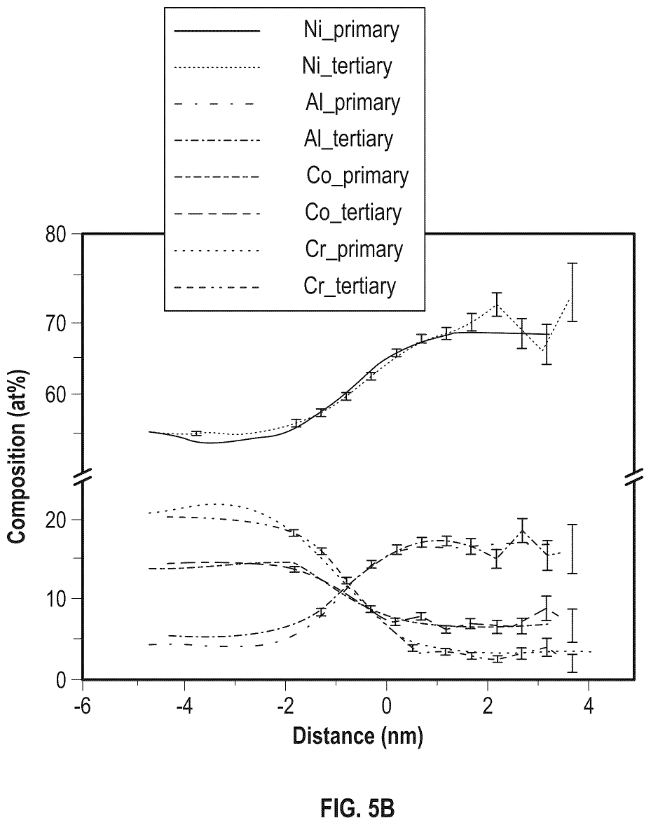

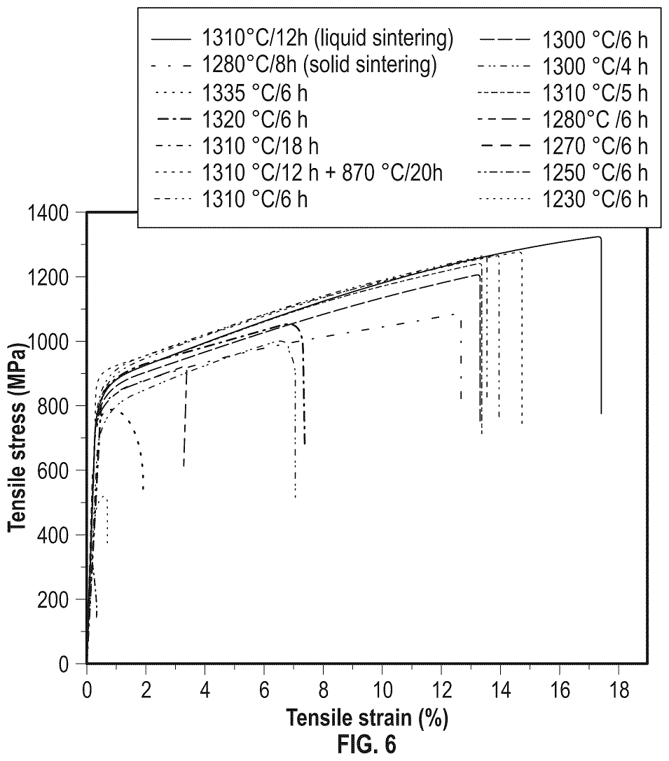

To determine the appropriate temperature range for sintering of Mar-M247 superalloy, a first thermal analysis was performed by differential scanning calorimetry (DSC). Through continuous heating of the Mar-M247 powders at a heating rate of 10° C./min, several characteristic temperatures were detected. As shown in FIG. 5A, the solvus temperature of primary γ′ phase (T_{γ′}), solidus temperature (Tₛ, i.e., alloy melting onset temperature), carbide dissolution temperature (T_{c}), and liquidus temperature (T_{L}) of the Mar-M247 superalloy are 1216, 1304, 1330, and 1362° C., respectively.

The thermal profile is shown in FIG. 5B. The samples were sintered in a tube furnace under protective argon atmosphere. A multi-step heating profile with a heating rate of 10° C./min was used to remove the moisture (100° C./1 hr), organic solvents (220° C./1 hr), and binding polymer (420° C./1.5 hrs) in the ink, followed by SLPS at the peak temperature of 1310° C. for 12 hrs and then air-cooled to room temperature, as illustrated in FIG. 5B.

The sintering temperature of Mar-M247 is higher than the formation temperature of M₂₃C₆ and M₆C carbides. In ageing treatment for traditional cast Mar-M247, the MC carbides can decompose to M₂₃C₆ carbides. These M₂₃C₆ carbides display the normal cube-cube orientation relationship with the FCC γ matrix: {100}_{M23C6}∥{100}_{γ}, <100>_{M23C6}∥<100>_{γ} and form discontinuously along the grain boundary. The sintered samples were directly air cooled after sintering which also inhibit the formation of detrimental M₂₃C₆.

### Results

### Microstructure

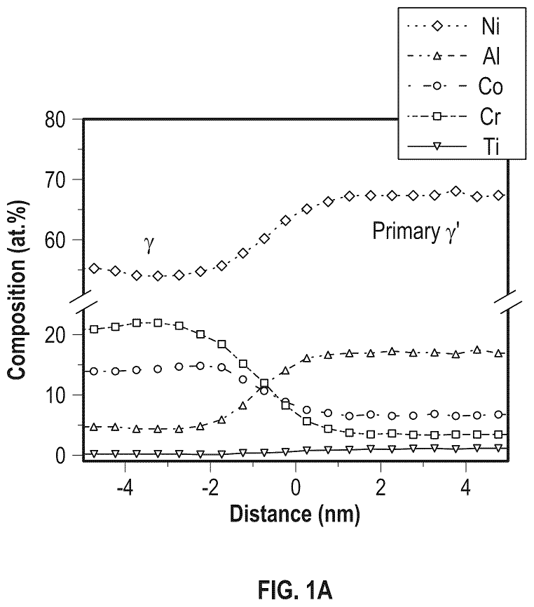

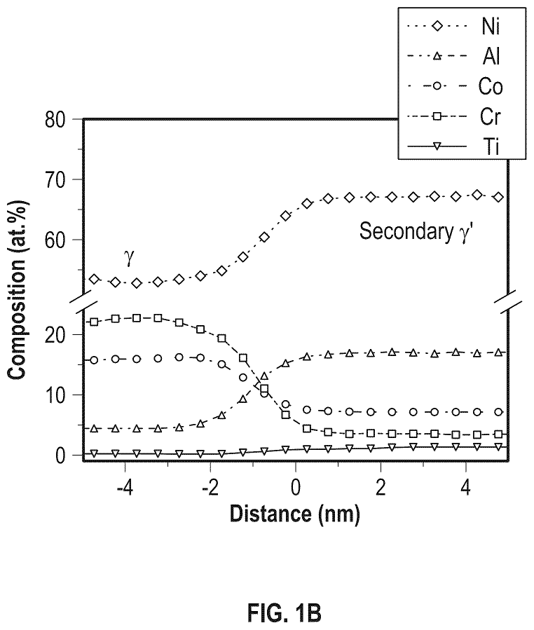

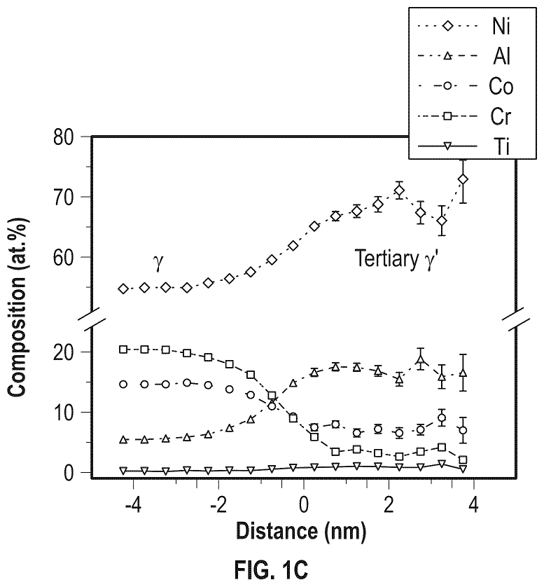

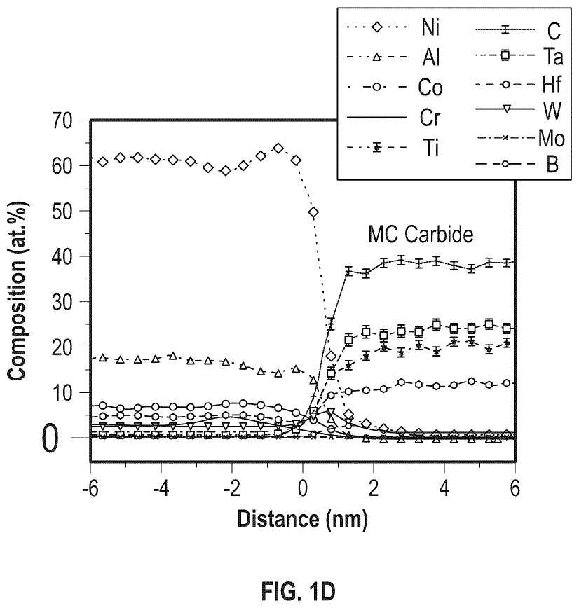

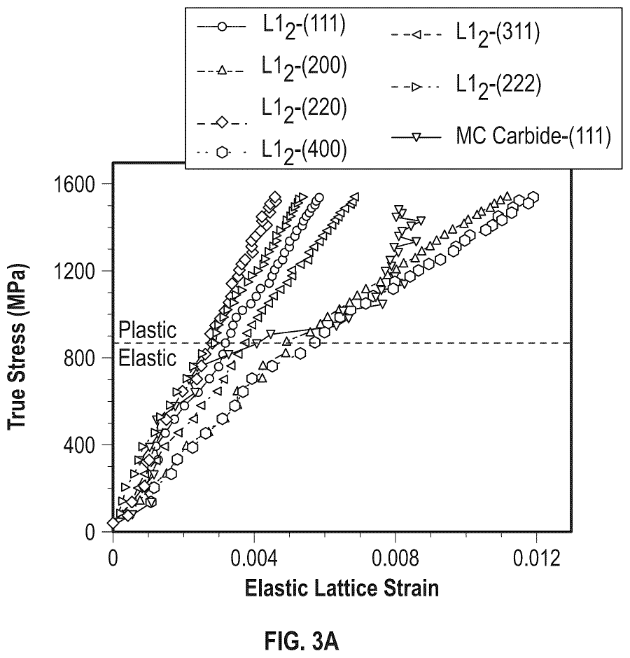

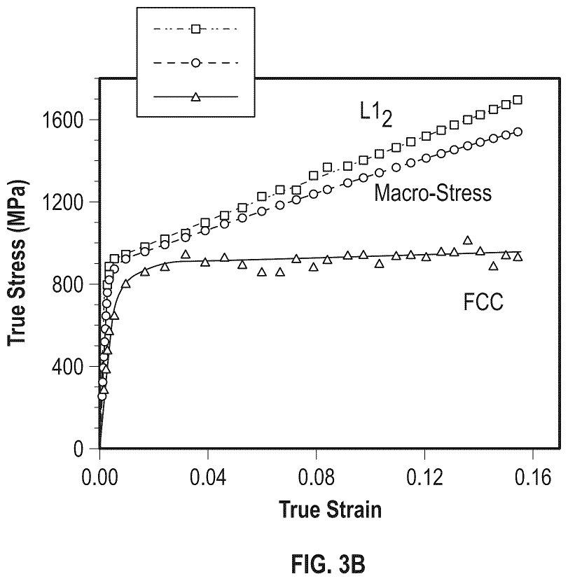

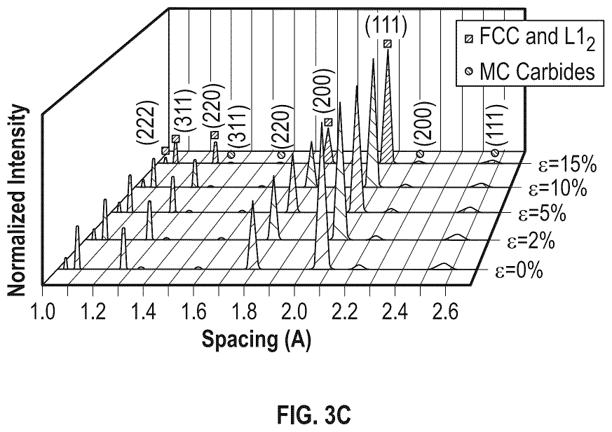

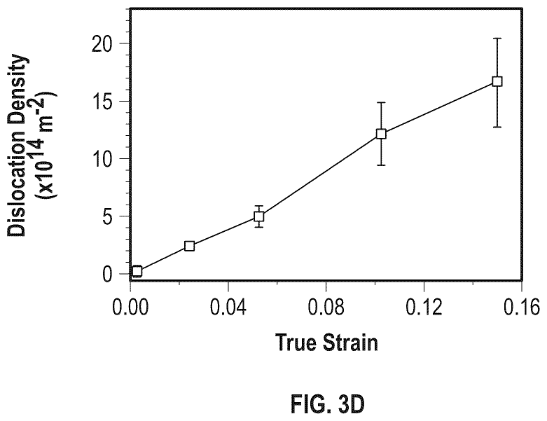

The relative density of the instant Mar-M247 alloy sintered at 1310° C. for 12 hours (hr) reaches 99.6% which is greater than about 98% of binder jetted Mar-M247 after sintering. A high-volume fraction of approximately 70% γ′ (L1₂) precipitates was achieved, as estimated by Rietveld refinement of the SXRD pattern (FIG. 3C). Of particular interest, these γ′ precipitates were distributed uniformly in the face-centered cubic (FCC) matrix and formed a hierarchical network with trimodal sizes across different length scales. The primary γ′ phase exhibits octodendritic shapes with typical sizes of 0.75 micrometer (μm). The size of the primary γ′ phase increases from 0.71 μm at the grain interior to 0.85 μm at the grain boundaries. The secondary and tertiary γ′ phases are near spherical with typical sizes of 74 nm and 15 nm, respectively. No texture was observed in the electron backscatter diffraction (EBSD) image which is attributed to the full inter-diffusion in the isothermal sintering process. The grain size was calculated to be 16.4 μm. The blocky MC carbides were uniformly distributed throughout the grains. The grain boundaries curving around the carbides indicate a significant pinning effect during the sintering process. The energy-dispersive X-ray (EDX) spectroscopy mapping results showed that the primary γ′ phase is enriched in Ni and Al and depleted in Cr and Co. Atom probe tomography (APT) results (FIG. 1A-1D) provide precise compositions for the trimodal γ′ phases which confirm the EDX results and MC carbides contain high concentrations of refractory elements (Ta, W, and Hf). Non-equilibrium diffusion zones are formed around the primary γ′ precipitates (FIGS. 5A-5B) and MC carbides (FIG. 1D). The interface width between γ′ and γ phases is almost the same for all three types of γ′ precipitates.

Note that the microstructure and phase constitution of the instant sintered Mar-M247 superalloys stand in sharp contrast from those of commercial Mar-M247 counterparts produced by casting and standard heat treatment (solutioning and aging). The average grain sizes of commercial Mar-M247 were reported to be 90 μm and larger than 500 μm. The Mar-M247 samples produced by laser metal deposition revealed a complex and heterogenous grain structure with mainly elongated grains (100 to 600 μm long, 30 to 100 μm wide). For commercial Mar-M247 alloys after aging, no tertiary γ′ phase was found and the size of the primary γ′ phase and the secondary γ′ phase varies from 0.40-1.35 μm and 50-500 nm, respectively. The rosette γ-γ′ eutectic, needle-like MC carbides, and M₂₃C₆ carbides were also frequently observed in the commercial Mar-M247 alloys lying in interdendritic regions and along grain boundaries, largely due to elemental segregation during solidification. The much coarser γ′ precipitates and the needle-like carbides can cause earlier cracking under loading.

In fact, attempts were made to manufacture Mar-M247 alloys using laser-based or electron beam based additive manufacturing, but the wide solidification range and the high additions of Al+Ti of Mar-M247 leads to high tendency of hot cracking and/or strain-age cracking. Preheating the building substrate to a very high homologous temperature and post-process such as hot isostatic pressing are effective ways to inhibit cracking, however, additional manufacturing steps will increase production time and cost. The surface roughness, Ra, of metal AM components, depending upon the material used, ranges from 9 μm to 50 μm. The high variation in surface roughness increases the uncertainty of a component's mechanical performance. The surface roughness of the disclosed supersolidus liquid-phase sintered and solid-state sintered Mar-M247 alloys reaches to approximately 1.5 μm and 1.6 μm, respectively.

Table 1 provides chemical compositions of phases in Mar-M247 measured by APT.

TABLE 1
Chemical compositions of phases in Mar-M247 measured by APT (atomic %)

| | Phase | | | | |
|---|---|---|---|---|---|
| | Primary γ′ | Secondary γ′ | Tertiary γ′ | | |
| Elements | phase | phase | phase | MC carbide | γ phase |
| Ni | 67.41 ± 0.22 | 67.17 ± 0.14 | 65.36 ± 1.83 | 2.2 ± 0.28 | 55.75 ± 0.25 |
| Al | 17.07 ± 0.18 | 16.92 ± 0.11 | 17.16 ± 1.53 | 0.07 ± 0.05 | 5.31 ± 0.11 |
| Fe | 0.06 ± 0.01 | 0.03 ± 0.01 | 0.04 ± 0.21 | 0.03 ± 0.03 | 0.11 ± 0.02 |
| Co | 6.84 ± 0.15 | 7.03 ± 0.08 | 7.37 ± 0.84 | 0.74 ± 0.16 | 13.7 ± 0.17 |
| Cr | 3.38 ± 0.09 | 3.45 ± 0.06 | 4.53 ± 0.71 | 0.22 ± 0.09 | 19.84 ± 0.2 |
| W | 3.04 ± 0.08 | 3.23 ± 0.05 | 2.99 ± 0.7 | 1.66 ± 0.24 | 2.94 ± 0.09 |
| Ti | 1.17 ± 0.05 | 1.11 ± 0.03 | 1.01 ± 0.33 | 20.21 ± 0.77 | 0.19 ± 0.02 |
| Mo | 0.26 ± 0.02 | 0.44 ± 0.02 | 0.65 ± 0.33 | 0.25 ± 0.09 | 0.57 ± 0.04 |
| Ta | 0.26 ± 0.02 | 0.38 ± 0.02 | 0.04 ± 0.15 | 22.51 ± 0.8 | 0.09 ± 0.02 |
| Hf | 0.03 ± 0.01 | 0.04 ± 0.01 | 0.05 ± 0.05 | 10.81 ± 0.59 | 0.09 ± 0.02 |
| C | 0.02 ± 0.01 | 0.06 ± 0.01 | 0.24 ± 0.05 | 38.5 ± 0.93 | 0.09 ± 0.02 |
| B | 0.07 ± 0.01 | 0.08 ± 0.01 | 0.04 ± 0.01 | 1.7 ± 0.24 | 0.03 ± 0.01 |

It is to be noted that no eutectics was observed in the instantly disclosed “as-sintered” Mar-M247 samples due to the limited volume fraction of the liquid phase (about 5%) in the sintering process (FIGS. 4A-4C) and the distribution of elements in the solidification was strongly impeded. Carbides that precipitate at grain boundaries (GB) are usually believed to be able to pin up the GB, preventing them from gliding, and increasing the alloy's strength at high temperatures. However, needle-like carbides are prone to cracking during tension tests. The lattice parameters of MC carbides, y phase and γ′ phase were determined to be 0.4443 nanometer (nm), 0.3585 nm and 0.3583 nm, respectively, using SXRD analysis (FIG. 3C). The MC carbides in the samples contain high Hf concentration (13 atomic %) favoring the formation of blocky MC carbides rather than needle-shaped ones to reduce the surface energy when the lattice misfit between the matrix and MC phase is close to 25%. Usually, the MC carbides can decompose to M₂₃C₆ as MC+γ→M₂₃C₆+γ′ during the ageing treatments. In the instantly disclosed “as-sintered” sample, the trimodal γ′ phase distribution was directly formed from air cooling without ageing which prevents the formation of needle-like M₂₃C₆ carbides.

The development of trimodal of γ′ precipitates during air cooling can be attributed to multiple distinct bursts of nucleation of precipitates at different undercooling below the γ′ solvus temperature. As temperature decreases below the γ′ solvus during cooling, the thermodynamic driving force for nucleation increases due to continuously increasing undercooling. The first generation of γ′ precipitates consume some of this driving force, especially in the local region surrounding the primary precipitates. This leads to the formation of far-field supersaturated regions in the γ matrix (FIGS. 5A-5B), which become potential sites for secondary nucleation at lower temperatures when the relative driving force increases. At lower temperatures, the higher thermodynamic driving force and nucleation rate result in a second nucleation burst, creating a large number of secondary γ′ precipitates and increasing the γ′ volume fraction. The high number of secondary precipitates leads to small inter-precipitate distances and rapid overlap of the diffusion fields, restricting their growth. The γ matrix between the secondary γ′ and the depleted zone around the primary γ′ retains a non-equilibrium composition but does not experience the nucleation burst until a large undercooling is achieved. A third burst of nucleation occurs at even lower temperatures. However, their growth is limited due to slower kinetics and limited supersaturation of solute. This multiple nucleation originates from the complex combination of the rapidly declining diffusivity of alloying elements with decreasing temperatures and the thermodynamic driving force related to the undercooling and the previous nucleation events.

For heavily deformed materials, it is recognized that sub-grain structure inhomogeneity mainly originates from the self-assembly of dislocations rather than the intergranular strain variations. Such dislocation activities give rise to strain fluctuations with the strain field around dislocations responsible for diffraction peak broadening. Based on the knowledge that FCC/L1₂-{311} crystallographic family shows relatively low symmetry and least sensitivity to intergranular/interphase strain, its diffraction elastic constants are closest to the bulk Young's modulus. As such, FCC/L1₂-{311} is often selected to represent the average phase-specific mechanical response. Following this notion, we used L1₂-{311} to estimate the average stress-strain response of γ′ precipitates and used rule of mixture to back calculate the FCC phase stress. The L1₂ phase exhibits higher strength and particularly higher strain-hardening rate (FIG. 3B), which makes a greater contribution to the overall strain hardening response than the FCC matrix, thereby promoting the large ductility of the Mar-M247 superalloy. The strain hardening is pronounced (σ_{UTS}-σ_{y}≈470 MPa, FIG. 2A1) even though the flow stress is at a high level. The flow-stress increase in Mar-M247 alloys was estimated to be 450 MPa based on the Taylor-type hardening formula which is in good agreement with the value measured during the in-situ tests. These observations indicate that the plastic deformation of the AM Mar-M247 superalloy is primarily mediated by dislocations.

### Mechanical Properties of Mar-M247 Superalloys

To study the mechanical properties of the Mar-M247 superalloys produced by DIW-based additive manufacturing, bulk specimens were fabricated by both supersolidus liquid-phase sintering (SLPS) (1310° C./12 h) and solid-state sintering (SSS) (1280° C./12 h) and performed uniaxial tensile tests at room temperature and elevated temperatures. As shown in FIG. 2A1-2A2, the instantly disclosed AM Mar-M247 superalloys exhibit a high yield stress of about 900 MPa, which is comparable to that of conventional cast counterparts. Of particular significance is the steady strain-hardening ability at high flow stresses, leading to a larger uniform elongation of 15%-17% and a higher ultimate tensile strength (UTS) up to ˜1350 MPa. The Mar-M247 sample produced by SSS showed a slightly lower strain-hardening rate and UTS (1270 MPa). Notably, the outstanding combination of uniform elongation and UTS of the instantly disclosed AM Mar-M247 superalloys well surpasses those of other Mar-M247 superalloys produced by casting or binder jetting additive manufacturing, as summarized in FIG. 2B.

The instantly disclosed AM Mar-M247 superalloys exhibit improved mechanical properties that well surpass conventional counterparts. Understanding their mechanical behavior and deformation mechanism is of paramount importance for designing robust superalloys by DIW-based additive manufacturing. In-situ SXRD under tension uncovered the origin of high strain hardening and the evolution of lattice strains in different {hkl} crystallographic families of L1₂ phases in the instantly disclosed as-sintered Mar-M247 samples. The load partitioning during plastic deformation of the 1310° C./12 h Mar-M247 sample is shown in FIGS. 3A-3D. All crystallographic reflections in the L1₂ phases exhibit a nearly linear increase of lattice strain against applied stress within the linear elastic regime. The {111} lattice from the MC carbides along the loading direction takes up a greater fraction of the applied load upon macro yielding, resulting in a large increase in the lattice strain, and then turns upwards, indicating the onset of plastic yielding through the passage of dislocations. This is associated with limited further accumulation of lattice strain. The {200} lattice strain of L1₂ phases along the loading direction also deviated from linearity after yielding but turned downwards. This stiffening response is caused primarily by the load shedding to the {200} and {400} reflections. In general, plastic deformation often triggers substantial broadening of diffraction peaks, which is mostly caused by the formation of inhomogeneous strain fields. With continuously increasing the applied strain, the broadening of many diffraction peaks is evident for both L1₂ and FCC phases (FIG. 3C), implying a strong accumulation of dislocations in the Mar-M247 superalloy during tensile loading. Upon loading, the dislocation density p increased from 3.3×10¹³ m⁻² at the stress-free state to 1.6×10¹⁵ m⁻² at 15% strain.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. An ink formulation for manufacturing a non-weldable superalloy, the ink formulation comprising:
a superalloy particle, the superalloy particle comprising
a primary element of Ni, Co, Fe, or a combination thereof, and
a secondary element comprising an element of Group 4 to Group 14, or a combination thereof, of the Periodic Table of the Elements, other than the primary element,
wherein the superalloy particle has a size of less than 30 micrometers;
a binder comprising a polymer; and
a solvent.

2. The ink formulation of claim 1, wherein the primary element is Ni, and the secondary element comprises Ta, Cr, Al, Mo, Co, Ti, Zr, C, W, Fe, Hf, B, Nb, V, Si, Re, or a combination thereof.

3. The ink formulation of claim 1, wherein the superalloy particle is a gas-atomized particle.

4. The ink formulation of claim 1,
wherein the binder comprises a block copolymer of poly(methyl methacrylate)-poly(n-butyl acrylate), or
wherein the solvent comprises tetrahydrofuran and 2-butoxyethanol, wherein a volumetric ratio of tetrahydrofuran to 2-butoxyethanol is 10:1 to 500:1.

5. The ink formulation of claim 1, wherein a volumetric ratio of the superalloy particle to the binder is 9.5:0.5 to 5.5:4.5.

6. An article comprising a non-weldable superalloy, the non-weldable superalloy comprising:
a primary element of Ni, Co, Fe, or a combination thereof; and
a secondary element comprising an element of Group 4 to Group 14, or a combination thereof, of the Periodic Table of the Elements, other than the primary element,
wherein a microstructure of the non-weldable superalloy comprises
a γ′ precipitate having a trimodal phase,
wherein a content of the γ′ precipitate is at least 60%, based on a total volume of the non-weldable superalloy, and
a γ matrix.

7. The article of claim 6, wherein the primary element is Ni, and the secondary element comprises Ta, Cr, Al, Mo, Co, Ti, Zr, C, W, Fe, Hf, B, Nb, V, Si, Re, or a combination thereof.

8. The non-weldable superalloy of claim 6, wherein the trimodal phase comprises
a primary γ′ phase having a size of about 300 nanometers to about 1 micrometer,
a secondary γ′ phase having a size of about 40 nanometers to about 200 nanometers, and
a tertiary γ′ phase having a size of about 0.1 nanometer to about 30 nanometers.

9. The article of claim 6, wherein the γ′ precipitate is distributed uniformly in the γ matrix.

10. The article of claim 6, wherein the microstructure further comprises an MC carbide, wherein M comprises an element of the primary element, the secondary element, or a combination thereof, other than carbon, and C is carbon.

11. The article of claim 6, wherein the non-weldable superalloy further comprises
a rosette γ-γ′ eutectic carbide, wherein a content of the rosette γ-γ′ eutectic carbide is less than 1%, based on the total volume of the non-weldable superalloy,
a needle-like carbide, wherein a content of the needle-like carbide is less than 1%, based on the total volume of the non-weldable superalloy,
a M₂₃C₆ carbide, wherein a content of the M₂₃C₆ carbide is less than 1%, based on the total volume of the non-weldable superalloy, or
a combination thereof.

12. The article of claim 6, wherein the non-weldable superalloy is free of the rosette γ-γ′ eutectic carbide, the needle-like carbide, the M₂₃C₆ carbide, or a combination thereof.

13. The article of claim 6, wherein the non-weldable superalloy has at least one of
a uniform elongation of 13% to 19% as measured according to ASTM E8/E8M standard,
an ultimate tensile strength of 1250 megapascals to 1450 megapascals according to ASTM E8/E8M standard,
a yield stress of 800 megapascals to 1000 megapascals according to ASTM E8/E8M standard, or
a surface roughness of 0.1 micrometer to 3 micrometers according to the ISO 21920-2:2021 standard.

14. The article of claim 6, which is crack-free.

15. A method of fabricating the article of claim 6, the method comprising:
providing an ink formulation comprising
a superalloy particle, the superalloy particle comprising
a primary element of Ni, Co, Fe, or a combination thereof, and
a secondary element comprising an element of Group 4 to Group 14, or a combination thereof, of the Periodic Table of the Elements, other than the primary element,
wherein the superalloy particle has a size of less than 30 micrometers,
a binder comprising a polymer, and
a solvent;
optionally mixing the ink formulation to provide a homogeneous solution;
loading the ink formulation into an extrusion device;
pressurizing and extruding the ink formulation in the extrusion device through a nozzle to provide an extruded filament; and
sintering the extruded filament thermally to fabricate an article comprising the non-weldable superalloy.

16. The method of claim 15, wherein the sintering comprises
placing the extruded filament in a furnace under an inert atmosphere comprising argon, nitrogen, or a combination thereof,
heating the extruded filament until reaching a peak temperature,
wherein the peak temperature is less than the solidus temperature of the superalloy, or alternatively, greater than the solidus temperature and less than the liquidus temperature of the superalloy,
maintaining the peak temperature for 5 hours to 20 hours to sinter the superalloy particles, and
cooling the sintered superalloy particles.

17. The method of claim 16, wherein the peak temperature is between 40° C. less than the solidus temperature and the solidus temperature of the superalloy, or between the solidus temperature and 20° C. greater than the solidus temperature.

18. The method of claim 15, wherein the sintering further comprises, before heating the extruded superalloy to the peak temperature,
heating the extruded filament until reaching a first temperature of 100° C. to 150° C., and maintaining the first temperature for 0.1 hour to 3 hours,
heating the extruded filament until reaching a second temperature of greater than the boiling point of the solvent, and maintaining the second temperature for 0.1 hour to 3 hours, and
heating the extruded filament until reaching a third temperature greater than the decomposition temperature of the binder, and maintaining the third temperature for 0.1 hour to 3 hours.

19. The method of claim 15, wherein the peak temperature is greater than the formation temperature of each of a M₂₃C₆ carbide and a M₆C carbide,
wherein M comprises an element of the primary element, the secondary element, or a combination thereof, other than carbon, and C is carbon.

20. The method of claim 15, wherein the pressurizing and the extruding is performed under a computer digital control, and wherein the extruded filament is deposited on a substrate as sequential layers to form a three-dimensional article.
